(19) United States
(12) Patent Application Publication
(10) Pub. No.: US 2026/0117776 A1
(43) Pub. Date: Apr. 30, 2026

(54) MOTOR PUMP AND HOUSING ASSEMBLY THEREFOR

(71) Applicant: COAVIS, Sejong-Si (KR)

(72) Inventors: Hyungmin KIM, Sejong-Si (KR); Kusung KWON, Daejeon (KR); Joonseup KIM, Sejong-Si (KR)

(73) Assignee: COAVIS, Sejong-Si (KR)

(21) Appl. No.: 19/372,488

(22) Filed: Oct. 29, 2025

(30) Foreign Application Priority Data
Oct. 29, 2024 (KR) 10-2024-0149744

(51) Int. Cl. F04D 13/06; F04D 29/08; F04D 29/42

(52) U.S. Cl. CPC F04D 13/0666; F04D 13/0693; F04D 29/086; F04D 29/426

(57) ABSTRACT

A motor pump comprises a first housing including an impeller, with a magnet securely mounted on the impeller to establish a magnetic flux oriented in a direction parallel to a rotating shaft of the impeller. The motor pump further includes a second housing coupled to the first housing, within which a circuit board is positioned. This circuit board includes a coil pattern formed thereon that generates magnetic flux parallel to the rotating shaft via electrical control, thereby interacting with the magnet. Additionally, a cap plate is disposed at an upper portion of the circuit board, preventing fluid from reaching a lower portion of the circuit board.

### BACKGROUND

### 1. Field

The present disclosure relates to a motor pump and a housing assembly therefor.

### 2. Description of Related Art

A motor pump is a fluid machine in which a motor that converts electrical energy into mechanical energy and a pump that moves fluid using driving force of the motor are combined.

In the automotive industry, motor pumps are used in a variety of systems and play a crucial role in improving vehicle performance and fuel efficiency, reducing emissions, etc. Compared to a pump that uses driving force of an engine, the motor pumps produce less noise and vibration, and are environmentally friendly because they use electric energy. With the advent of electric and autonomous vehicles, the motor pumps mounted on vehicles have expanded their applications, including a cooling system, a cooling and heating system, a fuel supply system, an oil supply system, a braking system, a steering system, etc.

The pump varies in structure and operating principle, and the electric motor, which is another key component constituting the motor pump, may adopt an axial flux motor (AFM), which offers advantages in terms of efficiency, output, and weight reduction, in addition to a conventional radial flux motor (RFM).

### RELATED PRIOR ART

WO 2023-082002 A1 (Published on 2023 May 19)
U.S. Pat. No. 10,141,804 B2 (Registered on 2018 Nov. 27)
KR 10-1237023 B1 (Published on 2013 Feb. 19)

### SUMMARY

The present disclosure provides a motor pump that can apply an axial flux motor having advantages in terms of efficiency and light weight, but does not require a waterproof coating for a circuit board, can fundamentally prevent a possibility of terminal leakage, and reduce and stably maintain a gap between a magnet and a stator circuit board, and a housing assembly therefor.

The problems 4 the present disclosure are not limited to those described herein, and other technical problems may be clearly understood by those skilled in the art from the following description.

According to an aspect of the present disclosure, a motor pump includes: a first housing; an impeller disposed in the first housing; a magnet restrainedly mounted on the impeller and disposed to form a magnetic flux in a direction parallel to a rotating shaft of the impeller; a second housing coupled to the first housing; a circuit board disposed in the second housing and having a coil pattern formed thereon that generates the magnetic flux in the direction parallel to the rotating shaft by electrical control to interact with the magnet; and a cap plate disposed at an upper portion of the circuit board and configured to block fluid flowing toward a lower portion of the circuit board.

The magnet may be disposed only between the impeller and the cap plate.

The magnet may be integrally attached to the impeller by overmolding.

The motor pump may further include a first yoke disposed between the magnet and the impeller.

The motor pump may further include a second yoke disposed on a lower surface of the circuit board.

Edges of the first housing and the second housing may be joined by fusion.

The first housing and the second housing may be fastened by a screw.

The cap plate and the second housing may be attached by fusion.

The cap plate may be formed of a non-magnetic material.

The cap plate may be formed of a resin material.

The cap plate may include stainless steel.

The motor pump may further include at least one sealing disposed between the cap plate and the first housing on a center side or an edge side of the cap plate.

According to another aspect of the present disclosure, a motor pump includes: a housing; an impeller disposed in the housing; a magnet restrainedly mounted on the impeller and disposed to form a magnetic flux in a direction parallel to a rotating shaft of the impeller; a circuit board having a coil pattern formed thereon that generates the magnetic flux in a direction parallel to the rotating shaft by electrical control within the housing to interact with the magnet; and a cap plate attached to the housing at an upper portion of the circuit board and configured to block fluid flowing toward a lower portion of the circuit board.

According to another aspect of the present disclosure, a housing assembly for a motor pump includes: a second housing formed to be coupled to a first housing in which a rotor including a magnet is disposed; a circuit board housed in the second housing, and having a coil pattern formed thereon that generates a magnetic flux in a direction parallel to a rotating shaft of the rotor by electrical control to interact with the rotor; and a cap plate disposed at an upper portion of the circuit board and attached to the second housing so as to seal an internal space between the circuit board and the second housing.

### BRIEF DESCRIPTION OF DRAWINGS

FIG. 1 is a schematic perspective view of an appearance of a motor pump according to an embodiment of the present disclosure.

FIG. 2 is a schematic perspective view of the motor pump of FIG. 1 viewed from an opposite side.

FIG. 3 is an exemplary longitudinal cross-sectional view of the motor pump of FIG. 1.

FIG. 4 is an exemplary exploded perspective view of the motor pump of FIG. 1.

FIG. 5 is an enlarged cross-sectional view of a portion of the motor pump of FIG. 3.

FIG. 6 is a conceptual diagram for describing a cooling action by fluid when the motor pump related to the present disclosure operates.

### DETAILED DESCRIPTION

The following describes a motor pump and its housing assembly with reference to the accompanying drawings in various aspects of the present disclosure. The items depicted in the drawings serve as a convenient representation of the present disclosure and may not correspond to actual dimensions. In certain cases, sizes or thickness may be exaggerated or reduced to better emphasize specific features and characteristics of the invention.

The present disclosure is not restricted to the configurations and methods outlined in the described embodiments. The embodiments may be adapted in various ways or manners to yield equivalent alternatives that may be replaced, and all or part of the embodiments may be selectively combined and arranged as appropriate.

The terms used in this specification and the following claims may not be restricted to their conventional dictionary meanings, but may be appropriately defined and understood to best describe the present disclosure. The terms “comprises” or “consists of,” as used herein, denote the inclusion of a combination of elements, components, or steps, and do not preclude the possibility of incorporating additional elements, components, or steps. Where a specific component is referred to as being “connected” or “coupled” to another, it should be understood that the components may be directly connected or coupled to each other, or indirectly connected or coupled to each other with one or more other components interposed therebetween. Conversely, when a specific component is described as “directly connected” or “directly coupled,” this indicates that no other component is positioned between them.

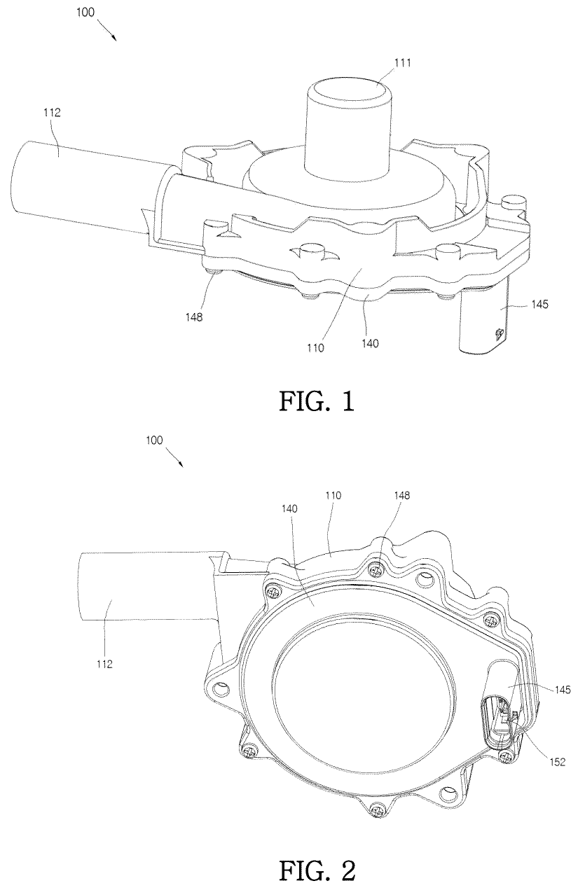

FIGS. 1 and 2 schematically illustrate an appearance of an exemplary motor pump 100 according to the present disclosure. The illustrated motor pump 100 is formed as an assembly of an upper housing 110 and a lower housing 140, which generally have a disc-shaped appearance. Here, the terms “upper portion” and “lower portion” are conveniently named with reference to FIG. 1. When the motor pump 100 is actually mounted on an application object, the direction and position of the motor pump 100 may differ. The fluid pumped through the motor pump 100 may be a liquid. In the present disclosure, the motor pump 100 for pumping liquid water will be primarily described. An exemplary application target of such a motor pump 100 may be a vehicle thermal management system or a coolant circulation pump for achieving the same.

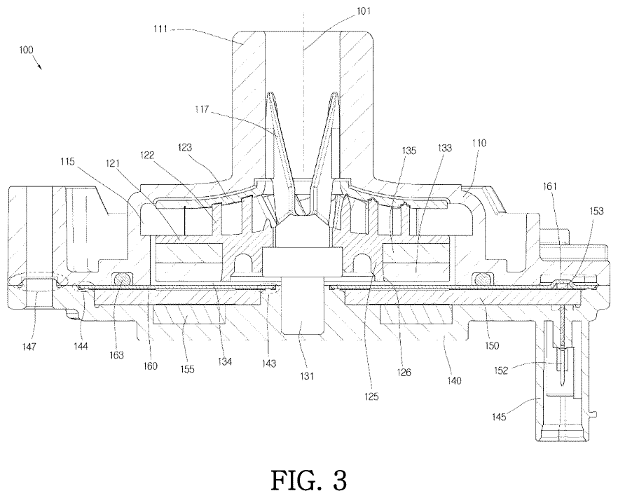

The upper housing 110 may have an inlet 111 disposed at a central side and an outlet 112 disposed at an edge. Since the inlet 111 is disposed vertically penetrating through the upper housing 110 and the outlet 112 is formed tangentially around the upper housing 110, the motor pump 100 may be configured in a form suitable for applying a centrifugal impeller 120 inside (see FIG. 3).

The lower housing 140 may be relatively thin compared to a vertical width of the upper housing 110 to include an installation space for the inlet 111, the outlet 112, and internal components for pumping. This is not only due to the adoption of an axial flux motor, as described below, but also to the fact that the overall vertical width may be reduced by a single rotor.

As shown in FIGS. 1 and 2, a terminal 145 and a connector 152 for connecting an external cable for power supply and control are provided on one edge of the lower housing 140. The terminals 145 and the connector 152 should be secured against water leakage when pumping water and circulating the water within the motor pump 100 for cooling. The present disclosure may be utilized as an effective method for securing this safety.

The upper housing 110 and the lower housing 140 may be fastened by a plurality of screws 148 disposed along the edge. In addition to or instead of fastening by the screw 148, as described above, a joint structure by fusion of the upper housing 110 and the lower housing 140 may also be applied.

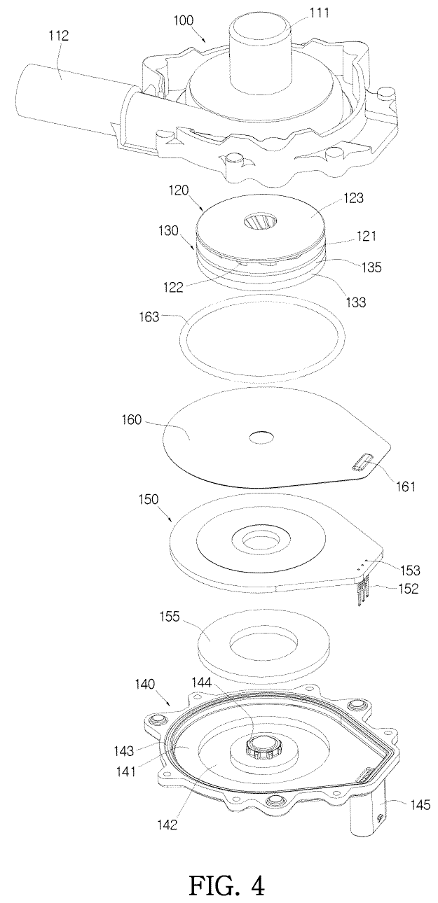

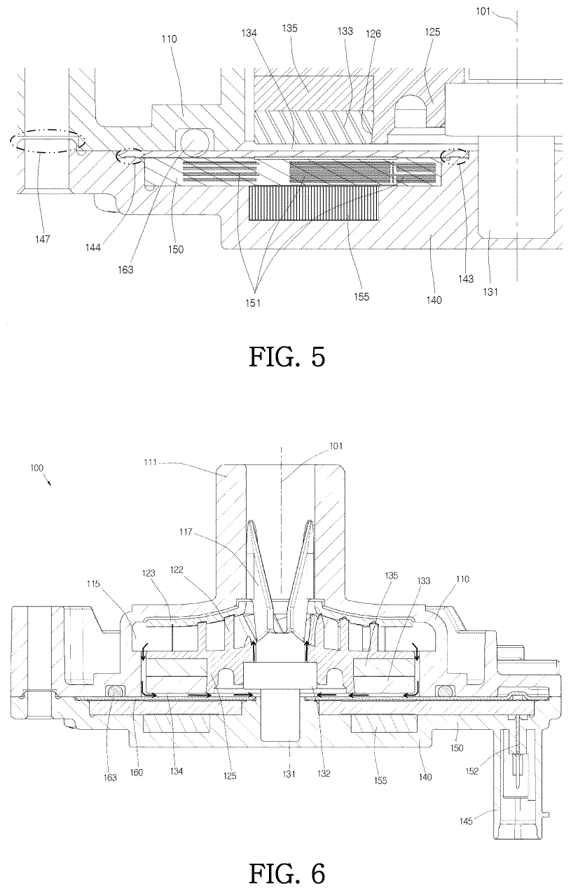

To describe an internal configuration of the motor pump 100 related to the present disclosure, reference will be made to cross-sectional views of FIGS. 3 and 5 and the exploded perspective view of FIG. 4.

As illustrated in these drawings of FIGS. 3, 4, and 5, the impeller 120 is housed within the upper housing 110. The impeller 120 may have a lower shroud 121 formed with a blade part 122, and an upper shroud 124 covering the blade part 122. Depending on the design requirements, the upper shroud 123 may be removed, and the present disclosure may be applied in this case as well. The detailed shape of the blade part 122 may be known, and thus a detailed description thereof will be omitted for brevity.

As shown in FIG. 4, a rotor 130 is restrainedly mounted on the impeller 120 so as to generate a magnetic flux in a direction parallel to the rotating shaft 101 of the impeller 120. Referring to FIG. 3, the rotor 130 is directly coupled to the impeller 120 and is integrally formed. To this end, as illustrated in FIG. 4, the impeller 120 may have an extension body 125 in which a lower portion of a lower shroud 123 extends, and a first yoke 135 and a magnet 133 are installed in the extension body 125. Also, a magnet 133 is disposed to form a magnetic flux in a direction parallel to the rotating shaft 101, as described above, in terms of the magnetic field. In terms of a shape, the magnet 133 may be in the form of a ring into which the extension body 125 may be inserted or filled. The magnet 133 may include a permanent magnet. In order to integrally manufacture the impeller 120 and the rotor 130, the magnet 133 may be coupled to the impeller 120 together with the first yoke 135 by an overmolding method. In order to maintain the magnet 133 and the first yoke 135 in a firmly fixed state with respect to the extension body 125 and the lower shroud 123, the extension body 125 may include a reverse-tapered part 126 whose diameter increases toward the lower portion.

A shaft 131 may be mounted on the upper housing 110 or the lower housing 140 to rotatably support the impeller 120 and rotor 130. Additionally, a support 117 may be formed on an inner wall of the inlet 111 to stably support the impeller 120.

Further, the lower housing 140 houses a circuit board 150 having a coil pattern 151 (see FIG. 5) formed therein, in which the coil pattern 151 may generate a magnetic flux in the direction parallel to the rotating shaft 101 to interact with a magnet 133 by electrical control. The coil pattern 151 may be laminated in multiple layers within the circuit board 150, and any known planar or three-dimensional winding pattern for magnetic interaction with the magnet 133 may be applied.

When viewed in a plan view, the circuit board 150 may have a protruding shape on one side for connection with a terminal 145. The connector 152 may be directly welded to the circuit board 150 by soldering or the like, and a fused part 147 may thus remain on the upper surface of the circuit board 150.

Since the circuit board 150 is supplied with power and allows current to flow under control for magnetic interaction with the magnet 133, heat may be generated. Since this generated heat may reduce an efficiency of the motor pump 100, the motor pump 100 may be configured to dissipate the generated heat of the circuit board 150 through the fluid pumped through the impeller 120. On the other hand, a cap plate 160 is installed on an upper portion of the circuit board 150 to block fluid flowing toward a lower portion of the circuit board 150. The cap plate 160 may be formed of a metal capable of rapidly discharging the generated heat from the circuit board 150 into the fluid (water) circulating on an upper surface of the cap plate 160. To facilitate the smooth magnetic interaction between the magnet 133 and the circuit board 150, the cap plate 160 may be formed of a non-magnetic resin or metal. The cap plate 160 may be, for example, polyphenylene sulfide resin (PPS resin) or stainless steel. A sheet or grease having excellent heat transfer properties may be disposed between the cap plate 160 and the circuit board 150. The cap plate 160 may be processed to have a complex shape inside the pump. As shown in FIGS. 3 and 4, the terminal welded part 153 formed on the upper surface of the circuit board 150 may be sealed while minimizing the gap between the circuit board 150 and the cap plate 160, such that the area where the terminal welded part 153 is disposed may form a dome-shaped part 161.

The cap plate 160 may be firmly attached to the lower housing 140 to prevent the fluid (water) from penetrating into the upper surface. An exemplary attachment method is to fuse the cap plate 160 to the lower housing 140 along an inner ring joint portion 143 and an outer ring joint portion 144 of the lower housing 140, as illustrated in FIGS. 3 to 5. This fusion may be accomplished using a laser or ultrasonic fusion method.

A second yoke 155 may be disposed on the lower surface of the circuit board 150 to improve the magnetic interaction between the magnet 133 and the coil pattern 151. The lower housing 140 may include a board seating groove 141 with a primary step formed therein for disposing the circuit board 150, and a yoke seating groove 142 with a secondary step formed therein for disposing the second yoke 155. As illustrated in FIG. 5, the second yoke 155 may be configured in a roll shape with a metal strip wound around the rotating shaft 101 of the impeller 120. The second yoke 155 thus wound may be fixed in shape by welding.

The lower housing 140 may be sealed by the cap plate 160 with the circuit board 150 and the second yoke 155 disposed therein. The assembly of the lower housing 140 may be attached to the upper housing 110 by fusion along the fused part 147 of the edge. The laser fusion or ultrasonic fusion may be applied as the exemplary methods. In the case of the laser fusion, the upper housing 110 or the lower housing 140 may be formed of a transparent or semi-transparent material to allow the laser to pass through. Additionally, the lower housing 140, the circuit board 150, the cap plate 160, and the second yoke 155 may be integrally manufactured by the overmolding.

A sealing 163 is disposed between the cap plate 160 and the upper housing 110 to seal the fluid introduced for cooling from the impeller 120. The sealing 163 may be arranged on one or both of the center and edge sides of the cap plate 160.

As illustrated in FIGS. 3 to 5, the magnet 133 directly attached to the impeller 120 is disposed only between the impeller 120 and the cap plate 160, and the motor pump 100 according to the present disclosure is of a single rotor 130 type. As a result, compared to the method in which the rotor is added to the lower portion of the circuit board 150, not only the size may be reduced by half the thickness of the additional rotor installed, but also there is no possibility of the fluid penetrating into the circuit board 150 through the cap plate 160, so it is free from leakage problems. Also, compared to the conventional technology that requires the sealing both the terminal and the circuit board, the sealing of the terminal 145 may be omitted, which is advantageous in terms of manufacturing and cost.

FIG. 6 illustrates a cooling action by fluid during the operation of the motor pump 100 related to the present disclosure, and the solid arrow indicates that, during the operation of the motor pump 100, the water in a volume region 115 flows along a gap 134 between the magnet 133 and the cap plate 160 to dissipate the heat from the cap plate 160 and the circuit board 150.

According to the motor pump and housing assembly described herein, the cap plate effectively blocks fluid from reaching the lower portion of the circuit board. As a result, it is unnecessary to apply waterproof coatings, such as epoxy resin, on the circuit board, and terminal leakage is fundamentally prevented due to the absence of fluid penetration beneath the circuit board, e.g., the fluid does not penetrate into the lower portion of the circuit board. In addition, by integrating the impeller and rotor into a single unit, the number of components and the overall thickness of the motor pump are reduced.

According to one embodiment of the present disclosure, the cap plate may be constructed from a thin material that possesses both non-magnetic and rigid properties, providing the advantage of reducing and consistently maintaining the gap with the magnet.

What is claimed is:

1. A motor pump, comprising:
a first housing;
an impeller disposed in the first housing;
a magnet restrainedly mounted on the impeller and disposed to form a magnetic flux in a direction parallel to a rotating shaft of the impeller;
a second housing coupled to the first housing;
a circuit board disposed in the second housing and having a coil pattern formed thereon that generates the magnetic flux in the direction parallel to the rotating shaft by electrical control to interact with the magnet; and
a cap plate disposed at an upper portion of the circuit board and configured to block fluid flowing toward a lower portion of the circuit board.

2. The motor pump of claim 1, wherein the magnet is disposed only between the impeller and the cap plate.

3. The motor pump of claim 1, wherein the magnet is integrally attached to the impeller by overmolding.

4. The motor pump of claim 3, further comprising:
a first yoke disposed between the magnet and the impeller.

5. The motor pump of claim 1, further comprising:
a second yoke disposed on a lower surface of the circuit board.

6. The motor pump of claim 1, wherein edges of the first housing and the second housing are joined by fusion.

7. The motor pump of claim 1, wherein the cap plate and the second housing are attached by fusion.

8. The motor pump of claim 1, wherein the cap plate is formed of a non-magnetic material.

9. The motor pump of claim 1, wherein the cap plate is formed of a resin material.

10. The motor pump of claim 1, wherein the cap plate includes stainless steel.

11. The motor pump of claim 1, further comprising:
at least one sealing disposed between the cap plate and the first housing on a center side or an edge side of the cap plate.

12. A motor pump, comprising:
a housing;
an impeller disposed in the housing;
a magnet restrainedly mounted on the impeller and disposed to form a magnetic flux in a direction parallel to a rotating shaft of the impeller;
a circuit board having a coil pattern formed thereon that generates the magnetic flux in the direction parallel to the rotating shaft by electrical control within the housing to interact with the magnet; and
a cap plate attached to the housing at an upper portion of the circuit board and configured to block fluid flowing toward a lower portion of the circuit board.

13. A housing assembly for a motor pump, comprising:
a second housing formed to be coupled to a first housing in which a rotor including a magnet is housed;
a circuit board disposed in the second housing, and having a coil pattern formed thereon that generates the magnetic flux in a direction parallel to a rotating shaft of the rotor by electrical control to interact with the rotor; and
a cap plate disposed at an upper portion of the circuit board and attached to the second housing so as to seal an internal space between the circuit board and the second housing.
